(19) United States
(12) Patent Application Publication
(10) Pub. No.: US 2015/0242086 A1
(43) Pub. Date: Aug. 27, 2015

(54) DRAG AND DROP EVENT SYSTEM AND METHOD

(71) Applicant: MARKPORT LIMITED, Dublin 2 (IE)

(72) Inventor: Grigory Mindlin, North Brunswick, NJ (US)

(21) Appl. No.: 14/186,436

(22) Filed: Feb. 21, 2014

(51) Int. Cl. G06F 3/0486; G06Q 30/02; G06F 3/0481

(52) U.S. Cl. CPC G06F 3/0486; G06F 3/0481; G06Q 30/0269; G06Q 50/01

(57) ABSTRACT

The example embodiments relate, in one aspect, to a drag and drop event system and method. In an example, the example embodiments may include receiving a drag and drop event message indicating that a first user has dragged content from a source window to a destination window on a split screen display of a first user device, determining an identifier of the first user in response to receiving the drag and drop event message, and retrieving a first user profile of the first user using the first user identifier, wherein the first user profile identifies a user category of the first user. The example embodiments may further include selecting an advertisement based on the user category, and communicating the advertisement to the first user device for presentation.

### 1. FIELD

This invention relates to the Internet. In particular, this invention relates to a system for tracking drag and drop events.

### 2. DISCUSSION OF THE RELATED ART

Mobile phones and other portable communication devices have dramatically changed how people communicate with one another. Software providers aim to make communication using such devices as effortless and efficient as possible for end users. As end users have shown some resistance to software purchases, other avenues for generating revenue have been explored, particularly data mining. In some instances, data mining techniques have been used to target advertisements, but there is room for improvement in these techniques.

### BRIEF SUMMARY

The example embodiments relate, in one aspect, to a drag and drop event system and method. In an example, the example embodiments may include receiving a drag and drop event message indicating that a first user has dragged content from a source window to a destination window on a split screen display of a first user device, determining an identifier of the first user in response to receiving the drag and drop event message, and retrieving a first user profile of the first user using the first user identifier, wherein the first user profile identifies a user category of the first user. The example embodiments may further include selecting an advertisement based on the user category, and communicating the advertisement to the first user device for presentation.

Other systems, methods, features, and advantages of the present disclosure will be or will become apparent to one with skill in the art upon examination of the following figures and detailed description. All such additional systems, methods, features, and advantages are included within this description, are within the scope of the disclosure, and are protected by the accompanying claims. Accordingly, the present disclosure is not restricted except in light of the attached claims and their equivalents.

### BRIEF DESCRIPTION OF THE FIGURES

For a better understanding of the present disclosure, non-limiting and non-exhaustive embodiments are described in reference to the following drawings. In the drawings, like reference numerals refer to like parts through all the various figures unless otherwise specified.

FIG. 1 illustrates a system for monitoring drag and drop events in accordance with example embodiments.

FIG. 2 illustrates an example user profile in accordance with example embodiments.

FIG. 3 illustrates an example content profile in accordance with example embodiments.

FIG. 4 illustrates a flow chart of a method for serving advertisements based on the occurrence of drag and drop events in accordance with example embodiments.

### DETAILED DESCRIPTION

The present disclosure now will be described more fully hereinafter with reference to the accompanying drawings, which form a part hereof, and which show, by way of illustration, specific exemplary embodiments by which the disclosure may be practiced. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Among other things, the present disclosure may be embodied as methods or devices. Accordingly, the present disclosure and its components may take the form of an entirely hardware embodiment, an entirely software embodiment or an embodiment combining software and hardware aspects. The following detailed description is, therefore, not to be taken in a limiting sense.

In some example embodiments, it may be efficient to use a split-screen display to simultaneously present windows for two or more software applications. Part of the efficiency may result from a user being able to share content by dragging and dropping the content from one window to another. The example embodiments may monitor what content is dragged and dropped to learn useful information about the user, the user's behavior patterns, other user's information in the user's social network, for targeting of advertisements, determining popularity of a particular content item, and improving application usability.

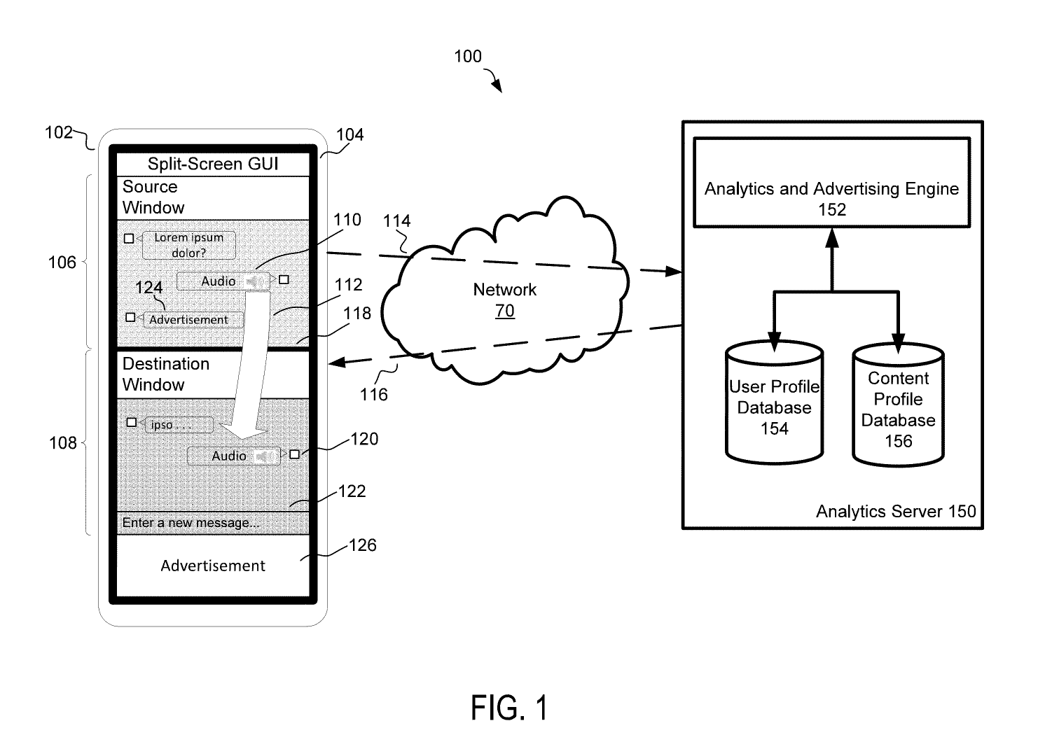

FIG. 1 illustrates an example system for monitoring drag and drop events in accordance with example embodiments. As depicted, system 100 may include a portable communication device 102 communicatively coupled to an analytics server 150 via network 70. Only a single instance of each is depicted, however, multiples of each may be used. Further, other devices and systems not depicted may also be included in system 100, but have been omitted to prevent obfuscating the present example. Each of portable communication device 102 and analytics server 150 may include one or more processors (e.g., microprocessors) and may include one or more non-transitory computer readable media storing computer readable instructions that, when executed by the processors, cause performance of the functions described herein. In some examples, portable communication device 102 may have a touch screen or otherwise be touch enabled.

Split-screen functionality may allow a user to have two different windows open on the same device 102 at the same time, thus enabling multi-tasking and content sharing between the windows. The multi-tasking aspect of this feature may allow end-users to participate and interact with various forms of communication. In an example, device 102 may store and execute a split-screen graphical user interface (GUI) computer program that divides a display screen 104 of device 102 into two or more windows.

In FIG. 1, source window 106 and destination window 108 are shown. The source window has been shaded with diagonal lines and is the upper rectangular portion of the display screen 104 associated with curly bracket 106. The destination window has been shaded with dots and is the lower rectangular portion of the display screen 104 associated with curly bracket 108. The source window 106 may refer to a particular region of a display screen 104 that is a source of content to be shared. The destination window 108 may refer to a particular region of a display screen 104 that is a destination of content being shared. Either of the two depicted windows in FIG. 1 may be a “source” window, but the windows have been named as “source” and “destination” windows to explain the present disclosure.

To make a desired window into a “source” window, a user may touch or otherwise select a particular window presented on display screen 104. The source window may be highlighted, focused, enlarged, or otherwise emphasized and the destination window may be greyed out, blurred, reduced, or otherwise de-emphasized to the user. In a text messaging example, field 122 may provide a text entry interface whereby text typed in field 122 is entered into the highlighted window. In another example, each window may be associated with its own field 122 for text entry.

The windows of display screen 104 may be arranged in other orientations. FIG. 1 shows the windows in a vertical orientation one above the other. In other examples, the windows may be placed next to one another horizontally or at any desired angle, the windows may partially overlap one another with the source window on top, and the like. The windows may also be of equal or differing sizes and may be shapes other than rectangles. For example, to resize the windows, a user may touch a boundary line 118 between the source and destination windows and drag the boundary line 118 downward to increase the size of the source window while simultaneously decreasing the size of the destination window, or vice versa. In other examples, the destination window may be represented by an icon and content may from the source window may be dragged to the icon for sharing.

A separate application may be launched within each window, and the split-screen GUI program may isolate the applications from one another such that a first of the applications does not know what input is being provided to the other applications, and vice versa. For example, the split-screen GUI program may provide a drop down menu permitting a user to select which application is launched in each window. Example applications include applications for communicating between users (e.g., text messaging, voice phone calls, email messaging, video chatting, etc.), an RSS feed, user generated content (e.g., a folder of files, images, video, etc.), a game, a geographic map, a publication, a web browser, an article, a blog, a voice mail, a user's contacts, rich media, audio, video, and/or multimedia editing software (e.g., playback, scrubbing, editing, etc.), and the like. In an example, the source window 106 may be from a web browser application and the destination window 108 may be from a text messaging application.

The split-screen GUI program may enable a drag and drop mechanism permitting the user to transfer and copy content form one window to another. Content may include audio, video, multimedia, an advertisement, an image, text, a geographic location (e.g., address of a restaurant), a map, multi-media, a game, a website, a website URL, any other sharable information, and any combination thereof. In an example, a user may provide input to select, drag, and drop content 110 from a first window to a second window. With reference to FIG. 1, a user may tap, touch, or otherwise select content 110 from the source window 106 (e.g., by placing a finger on touchscreen display at location of desired content for a predetermined amount of time), and may drag his or her finger across display screen 104 into a particular region of the destination window 108. The user may drop the content 110 by removing his or her finger from the display screen 104 at a desired location in the destination window 108. Arrows 112 depicts dragging and dropping of content 110 from the source window 106 to the destination window 108. Any manner of dragging and dropping may be used. For example, a device 102 may use a separate user input device (e.g., a mouse, a stylus, etc.) instead of or in addition to a user's finger as part of the drag and drop mechanism. In some examples, the dropped content 110 may appear in the destination window 108 at the end of a text messaging conversation, as indicated by element 120, represented by a sequence of messages moving from top to bottom along window 108. In other examples, the dropped content 110 may be highlighted or offset from a conversation.

In a more detailed example, source window 106 may display a webpage having an image and the destination window 108 may be for a text messaging application. The user may drag the image from the source window 106 to the destination window 108, causing the text messaging application to send the image to a device of a second user.

In another example, device 102 may have a geographic location detection system (e.g., GPS) and may display a pin (or other indicator) on a map presented in the source window 106. The pin may correspond to a user's current geographic location (e.g., geographic coordinates, current street address, etc.). The user may drag the map, pin and/or current geographic location to the destination window 108 for sending to the second user via, for example, a text messaging application.

In a further example, device 102 may present an audio clip in the source window 106 that is associated with audio editing software. The user may select the entire audio clip, a particular snippet of the audio clip that is less than the entirety of the audio clip, a modification of the audio clip, or any, and drag to the destination window 108 for sending to the second user via, for example, a text messaging application.

In yet another example, device 102 may present a text messaging application in both the source and destination windows, where the source window 106 is for a chat session between a first user and a second user, and the destination window 108 is for a chat session between the first user and a third user. The same text messaging application may implement both chatting sessions, or different text messaging applications may be used for each session. Either way, the second and third users may or may not be aware that the first user is chatting with both simultaneously unless the first user decides to drag and drop a message from one chat session into the other. Thus, another benefit of the split-screen GUI program is that it permits the first user to keep conversations private, when desired.

When the first user desires to share a message from the second user with the third user, the first user may identify a particular message, or portion thereof, in the source window 106 (e.g., by selecting a text message bubble with his or her finger for a predetermined amount of time) and drag the message or message portion to the destination window 108 for sending to the third user (e.g., by separating the user's finger from the touchscreen display). The shared message may be placed, for example, at the end of the conversation between the first and third user (e.g., at the location corresponding to element 120 in FIG. 1) and optionally may be highlighted to indicate that it is shared content. The message may also include other forms of content instead of or in addition to text (e.g. a link, an advertisement, multimedia, etc.).

When a drag and drop event occurs, the split-screen GUI program may record and report certain types of shared content information (e.g., metadata) that may be useful for learning about the user, his or her social connections, and the types of content being shared. The shared content information may be used, for example, to target advertisements to the user and his or her social connections, and to learn about the popularity of shared content (e.g., for setting of advertising rates). Examples of shared content information may include one or more of an identifier of the content (e.g., name or other unique identifier of the content), an identifier of the user (e.g., user's actual or username, etc.), an identifier of the user's device (e.g., phone number, device identifier, MAC address, etc.), an identifier of the recipient user (e.g., second user's actual or username, etc.), an identifier of the recipient user's device (e.g., phone number, device identifier, MAC address, etc.), a time at which the drag and drop event occurred, an identifier of the source application, an identifier of the destination application, and the like.

Portable communication device 102 may use some or all the shared content information to create a unique code to enable tracking of shared content from user to user and to identify with which other users a particular user shares content. When a first user uses the drag and drop mechanism to share content with a second user, the portable communication device 102 may create a unique code. In an example, the unique code may be a function of one or more of the content identifier, the source application identifier, the destination application identifier, the time of sharing, the user identifier, the recipient identifier, the user's device identifier, the recipient user's device identifier, a random number, a seed value, and any combination thereof. The function may be, for example, a hash function, an encryption function, a one-way function that does not permit recovery of the inputs to the function, a two-way function that permits recovery of the function inputs, and the like. When a drag and drop event occurs, portable communication device 102 may communicate the unique code along with the shared content to a recipient device of the second user.

If the second or subsequent user decides to share the same content with a third or subsequent user, the recipient device may forward the unique code received from the first user's device instead of creating a new one. For example, a first user may share an image with a second user, and the second user may forward the image to a third user. The device of the second user, instead of creating a new unique code, may forward the unique code received from the first user's device to the third user's device.

When a drag and drop event occurs, portable communication device 102 may also send a drag and drop event message to the analytics server 150. The drag and drop event message may include some or all of the types of shared content information, discussed above, and the unique code. The drag and drop message may also be encrypted or sent as clear-text. The unique code may permit the analytics server 150 to track which users have shared a particular instance of content to determine which users share content with one another. Because that and each subsequent recipient use the same unique code when sharing a particular instance of content, the analytics server 150 may identify relationships between sharing users and use these relationships for advertisement targeting.

In an example, analytics server 150 may include an analytics and advertising (AA) engine 152, a user profile database 154, and a content profile database 156. The AA engine 152 may process drag and drop event messages to create and update user profiles and content profiles, and to serve advertisements based on the user and content profiles. The user profile database 154 may store the user profiles, and the content profile database 156 may store the content profiles.

With reference to FIG. 1, portable communication device 102 may generate and communicate a drag and drop event message to the analytics server 150, represented by line 114. Analytics server 150 may process the event message, create and/or update profiles, select an advertisement, and communicate the advertisement to device 102, represented by line 116.

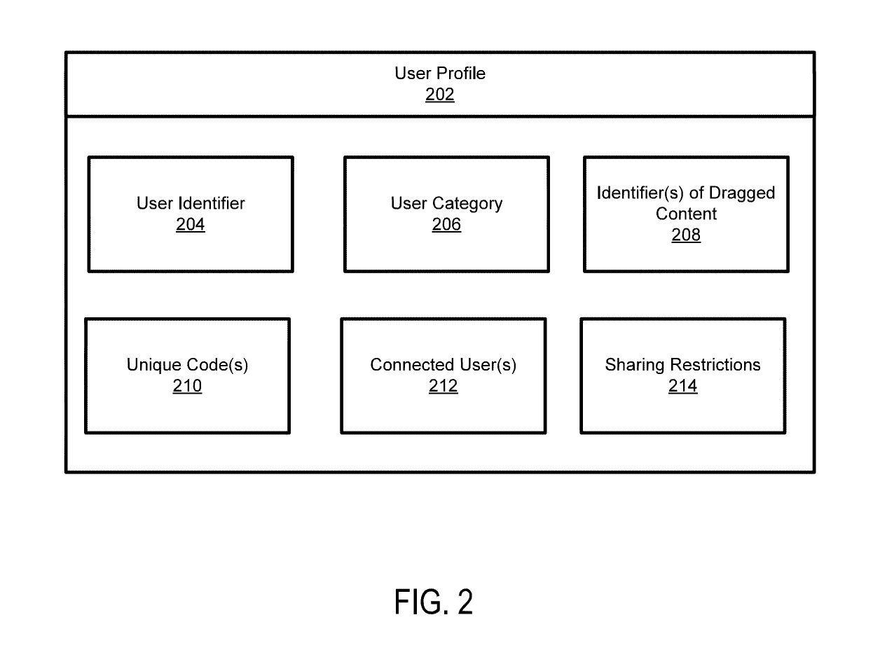

FIG. 2 illustrates an example of a user profile in accordance with example embodiments. In an example, user profile 202 may include a user identifier 204 of a particular user, a user category 206, identifiers of one or more dragged content items 208, and one or more unique codes 210, identifiers of one or more connected users 212, and sharing restrictions 214. The analytics server 150 may create a user profile 202 for each user based on the drag and drop event messages, from information provided by each user, from information derived from other sources, and any combination thereof.

The user category 206 may store geographic and/or demographic information learned about a particular user. The user category 206 may also store information about purchasing habits of the user. Examples of purchasing habits include purchase frequency, purchase frequency for particular products, time of day when the user makes purchases, categories of products/services the users tends to purchase, and the like.

The identifiers of one or more dragged content items 208 may include a listing of the content the particular user has shared within a predetermined time period or ever. The unique codes 210 may list the unique codes for the content the particular user has shared within the predetermined time period or ever.

Connected users 212 may be a list of one or more other users with which a first user has shared content within the predetermined time period or ever. The list may include a user identifier for each of the other users. Connected users 212 may also identify some or all other users who have directly or indirectly received content that originated from the first user. For example, a first user may be friends with a second user, but not a third user who frequently receives shared content from the first user by way of the second user. Even though the first user may not have ever, or rarely, directly share content with the third user, analytics server 150 may include the third user in the connected users 212 for the first user.

For example, analytics server 150 may receive a drag and drop event message having a unique code from a second user's device, where the unique code is associated with content originating from a first user's device. The analytics server 150 may retrieve a user profile 202 for the second user from the user profile database 154 in response to receiving the event message, search the user profile database 154 to identify user profiles of all users that have shared content with that same unique code, and update data on connected users 212 of the first user's profile, the second user's profile, and in the user profiles for any other identified users, to indicate a social connection between the first user, the second user, and each of the other identified users. The connected users data may include, for example, a user identifier for each of the users, a time stamp indicating the last time that each of the users shared content, and a degree of separation between each user (i.e., first user shared content with fourth user via second and third users on Mar. 17, 2014).

Sharing restrictions 214 may include any restrictions a first user places on subsequent users further sharing of content. The portable communication device 102 may also locally store these restrictions. In an example, the sharing restrictions 214 may limit how many additional times a recipient user may further share drag and dropped content originating from the first user. The sharing restrictions 214 may be data embedded in content communicated by the first user that limits how the second and subsequent users may share content originating from the first user. For example, a first user may not wish to have an image of the first user's family be further shared at all, thus a recipient second user cannot drag and drop a received image to share with a third user. In other instances, the first user may forward publically available information and may not place any restrictions on re-sharing of content. The split-screen GUI program may provide an interface enabling the first user to specify sharing restrictions for different types of content before the first user has even attempted to share any content. In another example, the split-screen GUI program may provide a pop-up window or other reminder at the time of sharing prompting the first user to place any sharing restrictions on content being dragged and dropped.

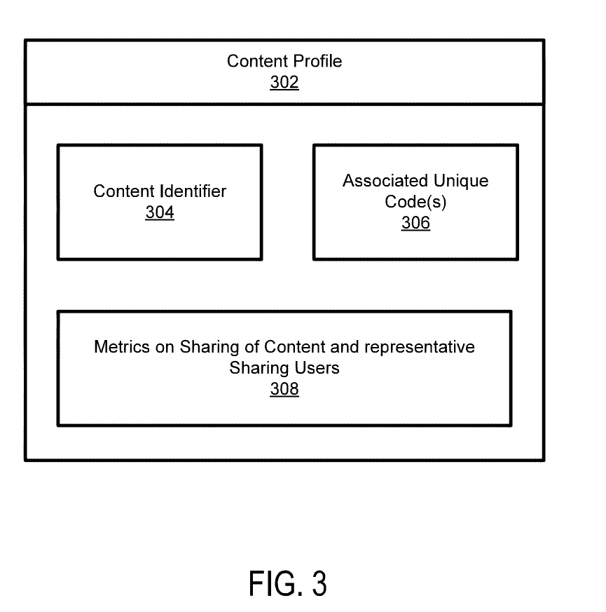

In addition to creating a profile for the user, analytics server 150 may create a profile for shared content. FIG. 3 illustrates an example content profile in accordance with example embodiments. Content profile 302 may include a content identifier 304, associated unique codes 306, and metrics on sharing of the content and representative sharing users 308. The content identifier 304 may uniquely identify a particular content item (e.g., image). The associated unique codes 306 may identify any unique codes created when that content item is shared. The metrics may include data on how many times a particular content item has been shared, identifiers of one or more source applications that shared the particular content item, identifiers of one or more destination applications that received the particular content item, and information about representative users sharing the content (e.g., demographic, geographic, and the like).

Analytics server 150 may provide the metrics 308 to a content provider, advertiser, or other interested third party to, for example, set advertising rates for content items being shared. In an example, analytics server 150 may notify a content provider or advertiser that a particular content item has been shared a predetermined number of times per hour within the past 4 hours (or other desired time interval) by users within a particular category (e.g., teenage girls from affluent households in the northeastern United States). This information may be valuable to content providers wanting to educate advertisers about the value of a particular content item, and to advertisers desiring to finely target a particular audience with its advertising expenditure.

Analytics server 150 may process the user profiles and content profiles to target advertisements to one or more users. In an example, analytics server 150 may determine what types of users are currently engaged with their devices and their social connections, and select advertisements to target those users. Initially, analytics server 150 may process a received drag and drop event message to determine whether a first user is actively engaged with his or her device 102 based on how recently the drag and drop event occurred, and retrieve a user profile 202 from the user profile database 154 for that user based on the user identifier.

Analytics server 150 may process the user profile 202 to determine a user category 206 for the first user and to identify connected users 212. The user category 206 may be used to target an advertisement to the first user, and data on connected users 212 may be used to target an advertisements to the users having a social connection to the first user. In this example, the user category 206 may indicate that the user is a 45 year old male, living in New York, N.Y., having an estimated income of $55,000-$75,000, and who has made purchases from forty five different stores within the past six months.

Based on the identified user category, the analytics server 150 may select an advertisement for that user and communicate the advertisement to the user device 102. In an example, analytics server 150 may identify available advertisements for any of the 45 stores where the first user has recently shopped, select one of the available advertisements based on, for example, a highest amount the advertiser is willing to pay to serve an advertisement to the first user, and send the advertisement to the first user's device. With reference to FIG. 1, device 102 may display the received advertisement within a conversation bubble 124 of the source window 106 as part the first user's conversation. In another example, device 102 may display the received advertisement as a banner advertisement 126. The received advertisement may be displayed at any desired location on the display screen and may be presented as a pop-up window.

Selection of an advertisement may also be based on the amount an advertiser is willing to pay to target a particular user. For example, each advertisement may be associated with a user category and a price per delivered advertisement. Analytics server 150 may select an advertisement for that user category and having the highest price for delivery. For instance, analytics server 150 may provide an online marketplace where advertisers submit bids on one or more user categories, and may charge an advertiser its bid amount when an advertisement is delivered to a user within that user category.

In another example, analytics server 150 may select advertisements to send directly or indirectly to a second user when a drag and drop event message is received from a first user. The second user may be identified in the event message (e.g., chatting with the first user via the destination window) or from the first user's profile (e.g., second user listed as a connected user 212). Analytics server 150 may retrieve the second user's profile from the user profile database 154 based on a second user identifier obtained from the event message or the data on the connected users 212 from the first user's profile. Analytics server 150 may then select an advertisement for the second user similar to the discussion provided above for the first user. In some examples, the first and second user may receive the same advertisement, or they may receive different advertisements.

Analytics server 150 may deliver the selected advertisement indirectly to the second user via asking the first user to forward the advertisement, or directly from the analytics server 150. For example, analytics server 150 may communicate an advertisement to the device 102 of the first user that is presented in the source window 106 in conversation bubble 124. The advertisement bubble 124 may include instructions prompting the first user to drag and drop it into a destination window associated with the second user (e.g., for sending via a text messaging application). The advertisement may optionally provide an incentive to the first user for doing so (e.g., loyalty points, reward, discount, partial payment of bill for service plan, etc.).

When the first user begins to drag the advertisement, split-screen GUI application of device 102 may determine whether a destination window is associated with a communication session with the second user. If not, split-screen GUI program may automatically cause a destination window 108 to appear providing an application for enabling communication with, and for forwarding the advertisement to, the second user.

When the advertisement has been forwarded to the second user, split-screen GUI program may communicate a drag and drop event message to the analytics server 150. In response, analytics server 150 may award an incentive to the first user and may track how the second user responds to the advertisement. For example, analytics server 150 may reward the first user for forwarding of the advertisement and may additionally reward the first user if the second user also forwards the advertisement and/or purchases the advertised product and/or service. The second user, and any further downstream users, may be similarly rewarded for forwarding the advertisement and/or when downstream users make purchases.

Analogous to the discussion provided above, the split-screen GUI program may generate a unique code associated with the initial drag and drop event message to track passing of the unique code between users to identify the first user and any other downstream users who received the same advertisement. Analytics server 150 may target selected users for additional incentives based on his or her ability to influence downstream users to forward advertisements and/or to purchase advertised products and/or services.

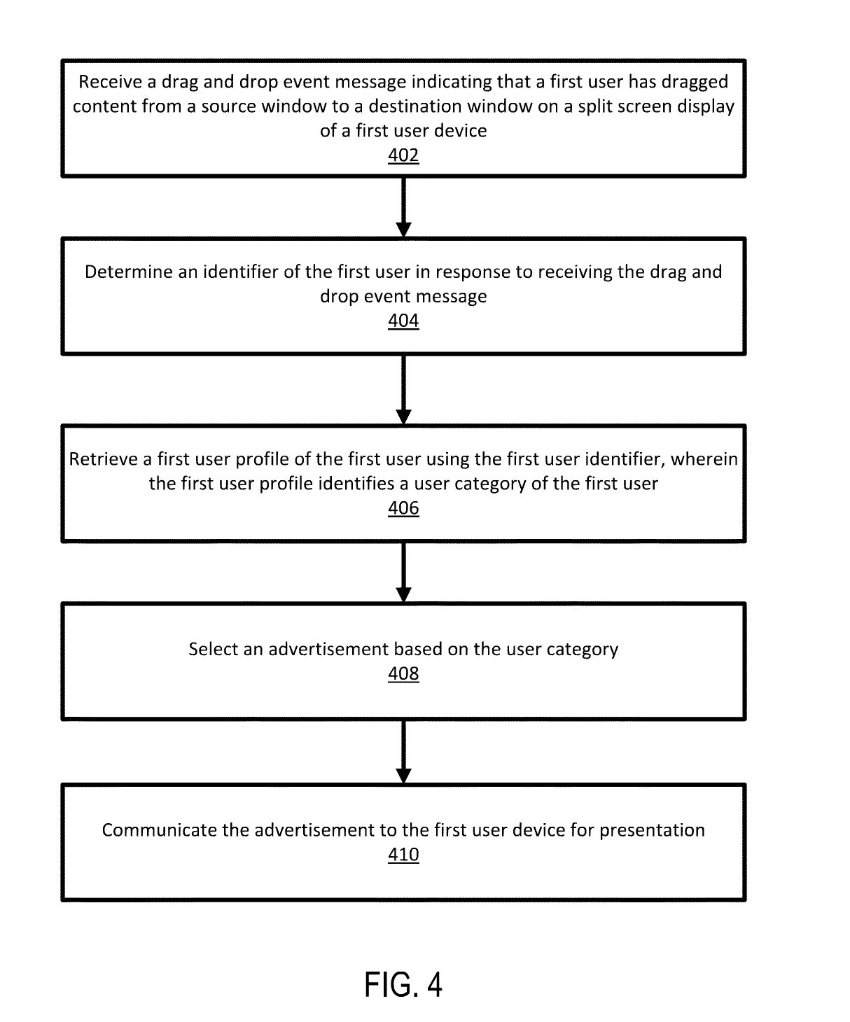

FIG. 4 illustrates a flow chart of a method for serving advertisements based on the occurrence of drag and drop events in accordance with example embodiments. The flow diagram may be implemented by a system or apparatus, such as, for example, analytics server 150. Each of the blocks shown in the flow diagram may be repeated one or more times, one or more of the blocks may be modified, and one or more of the blocks may be omitted. The method may be stored on a non-transitory computer readable medium as computer executable instructions. The computer executable instructions, when executed by at least one processor, may cause at least one computer or other device to perform the blocks as steps of a method one or more times. The flow diagram may begin at block 402.

In block 402, the method may include receiving a drag and drop event message indicating that a first user has dragged content from a source window to a destination window on a split screen display of a first user device. In block 404, the method may include determining an identifier of the first user in response to receiving the drag and drop event message. In block 406, the method may include retrieving a first user profile of the first user using the first user identifier, wherein the first user profile identifies a user category of the first user. In block 408, the method may include selecting an advertisement based on the user category. In block 410, the method may include communicating the advertisement to the first user device for presentation. The method may end, may return to any of the preceding steps, and may repeat one or more times.

With reference again to FIG. 1, network 70 is shown interconnecting various components. Network 70 may be the Internet, WAN, LAN, Wi-Fi, other computer networks (now known or invented in the future), and/or any combination of the foregoing. It should be understood by those of ordinary skill in the art having the present specification, drawings, and claims before them that network 70 may connect the various components over any combination of wired and wireless conduits, including copper, fiber optic, microwaves, and other forms of radio frequency, electrical and/or optical communication techniques. It should also be understood that network 70 may be connected to any other network in a different manner. The interconnections between devices in FIG. 1 are examples and not limitations. Any device depicted in FIG. 1 may communicate with any other device via one or more networks.

The system depicted in FIG. 1 can be utilized with a variety of different portable communication devices 102, including but not limited to PDA's, cellular phones, smart phones, laptops, tablet computers, and other mobile devices that preferably include cellular voice and data service as well as preferably access to consumer downloadable applications. One such device could be an iPhone, Motorola RAZR or DROID; however, the present disclosure is preferably platform and device independent. For example, a portable communication device technology platform may be Microsoft Windows Mobile, Microsoft Windows Phone 7, Palm OS, RIM Blackberry OS, Apple OS, Android OS, Symbian, Java or any other technology platform. For purposes of this disclosure, the present disclosure has been generally described in accordance with features and interfaces that are optimized for a smart phone utilizing a generalized platform, although one skilled in the art would understand that all such features and interfaces may also be used and adapted for any other platform and/or device. For instance, the example embodiments may be implemented on a client device, such as a desktop computer, instead of communication device that is portable.

Device 102 may be a general purpose computer having, among other elements, a microprocessor (such as from the Intel Corporation or AMD); volatile and non-volatile memory; one or more mass storage devices (i.e., a hard drive, RAM, ROM, etc.); one or more removable memory cards, various user input devices, such as a mouse, a keyboard, or a microphone; and a video display system. The mass memory provides storage for computer readable instructions and other data, including a basic input/output system (“BIOS”) and an operating system for controlling the operation of the portable communication device. In one aspect, the general-purpose computer may be controlled by the WINDOWS XP® operating system. It is contemplated, however, that the present system would work equally well using a MACINTOSH computer or even another operating system such as a WINDOWS VISTA, UNIX, LINUX or a JAVA based operating system, to name a few.

Device 102 may include a mobile network interface to establish and manage wireless communications with a mobile network operator. The mobile network interface uses one or more communication protocols and technologies including, but not limited to, global system for mobile communication (GSM), 3G, 4G, code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols to communicate with the mobile network of a mobile network operator. Accordingly, the mobile network interface may include as a transceiver, transceiving device, or network interface card (NIC). It is contemplated that the mobile network interface and short proximity electromagnetic communication device could share a transceiver or transceiving device, as would be understood in the art by those having the present specification, figures, and claims before them.

Device 102 may include a location transceiver that can determine its physical coordinates on the Earth's surface typically as a function of its latitude, longitude and altitude. This location transceiver preferably uses GPS technology, so it may be referred to herein as a GPS transceiver; however, it should be understood that the location transceiver can additionally (or alternatively) employ other geo-positioning mechanisms, including, but not limited to, triangulation, assisted GPS (AGPS), E-OTD, CI, SAI, ETA, BSS or the like, to determine its physical location on the Earth's surface.

Device 102 may further include a user interface that provides some means for the user to receive information as well as to input information or otherwise respond to the received information. As is presently understood (without intending to limit the present disclosure thereto) this user interface may include a microphone, an audio speaker, a haptic interface, a graphical display, and a keypad, keyboard, pointing device and/or touch screen.

Device 102 may also include a device identification memory dedicated to identify the device, such as a SIM card. As is generally understood, SIM cards contain the unique serial number of the device (ESN), an internationally unique number of the mobile user (IMSI), security authentication and ciphering information, temporary information related to the local network, a list of the services the user has access to and two passwords (PIN for usual use and PUK for unlocking). As would be understood in the art by those having the present specification, figures, and claims before them, other information may be maintained in the device identification memory depending upon the type of device, its primary network type, home mobile network operator, etc.

Device 102 may operably connect to analytics server 150, via one of many available internet browsers including, but not limited to, Microsoft's Internet Explorer, Apple's Safari, and Mozilla's Firefox. Via network 70, end users may communicate with analytics server 150 using an http-based website, although other graphical user interfaces can be used with the present system.

Analytics server 150 may be a general purpose computer that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. Analytics server 150 may be running on any one of many operating systems including, but not limited to WINDOWS, UNIX, LINUX, MAC OS, or Windows (XP, VISTA, etc.). It is contemplated, however, that any suitable operating system may be used for the present disclosure. Analytics server 150 may be a cluster of web servers, which may each be LINUX based and supported by a load balancer that decides which of the cluster of web servers should process a request based upon the current request-load of the available server(s). Analytics server 150 may be in multiple locations but may act together as a single server such as in a cloud based computing system.

Analytics server 150 may perform functions in serial or in parallel on the same computer or across a local or wide area network distributed on a plurality of computers, where the computer may be controlled by the Linux operating system. It is contemplated, however, that the system would work equally well using a Macintosh® operating system or even another operating system such as Windows®, Windows CE, Unix, or a Java® based operating system, to name a few. Some details of a preferred analytics server 150 is shown in FIG. 1 with it being understood that any server has further aspects not shown to avoid obscuring the example embodiments.

The various participants and elements described herein may operate one or more computer apparatuses to facilitate the functions described herein. Any of the elements in the above-described Figures, including any servers, user terminals, or databases, may use any suitable number of subsystems to facilitate the functions described herein.

Any of the software components or functions described in this application, may be implemented as software code or computer readable instructions that may be executed by at least one processor using any suitable computer language such as, for example and not limitation, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present disclosure as described above can be implemented in the form of control logic using computer software in a modular or integrated manner. Based on the disclosure and teachings provided herein, a person of ordinary skill in the art may know and appreciate other ways and/or methods to implement the present disclosure using hardware, software, or a combination of hardware and software.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

One or more features from any embodiment may be combined with one or more features of any other embodiment without departing from the scope of the disclosure. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

Methods or processes in accordance with the various embodiments of the disclosure may be implemented by computer readable instructions stored in any media that is readable and executable by a computer system. A machine-readable medium having stored thereon instructions, which when executed by a set of processors, may cause the set of processors to perform the methods of the disclosure. A machine-readable medium may include any mechanism for storing or transmitting information in a form readable by a machine (e.g., a computer). A machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.).

While various embodiments of the present disclosure have been described above, it should be understood that such disclosures have been presented by way of example only, and are not limiting. Thus, the breadth and scope of the present disclosure should not be limited by any of the above-described exemplary embodiments, but should be defined only in accordance with the following claims and their equivalents. While the specification is described in relation to certain implementations or embodiments, many details are set forth for the purpose of illustration. Thus, the foregoing merely illustrates the principles of the disclosure, and the disclosure is not limited thereto. For example, the disclosure may have other specific forms without departing from its spirit or essential characteristic. The described arrangements are illustrative and not restrictive. To those skilled in the art, it will be clear that the disclosure is susceptible to additional implementations or embodiments and certain of these details described in this application may be varied considerably without departing from the basic principles of the disclosure. It will thus be appreciated that those skilled in the art will be able to devise various arrangements which, although not explicitly described or shown herein, embody the principles of the disclosure and, thus, within its scope and spirit.

1. A computer-implemented method comprising:
receiving a drag and drop event message indicating that a first user has dragged content from a source window to a destination window on a split screen display of a first user device;
determining, by a processor, an identifier of the first user in response to receiving the drag and drop event message;
retrieving, by the processor, a first user profile of the first user using the first user identifier, wherein the first user profile identifies a user category of the first user;
selecting, by the processor, an advertisement based on the user category; and
communicating the advertisement to the first user device for presentation.

2. The method of claim 1, wherein the destination window is associated with a software application implementing a communication session between the first user device and a user device of a second user, the method further comprising communicating the advertisement to the second user device for presentation.

3. The method of claim 1, wherein the advertisement comprises an instruction for prompting the first user to forward the advertisement to a second user.

4. The method of claim 3, further comprising selecting the second user based on the first user profile indicating a social connection between the first user and the second user.

5. The method of claim 1, wherein the event message comprises a unique code that is a function of a time that a drag and drop event occurred on the first user device and an identifier of the content.

6. The method of claim 5, further comprising:
identifying a second drag and drop event message comprising the unique code;
determining a second user identifier in response to receiving the second drag and drop event message, wherein the second user identifier is associated with a second user; and
updating the first user profile to indicate a social connection between the first user and the second user.

7. The method of claim 6, further comprising:
retrieving a second user profile of the second user using the second user identifier, wherein the second user profile identifies a second user category of the second user;
selecting a second advertisement based on the second user category; and
communicating the second advertisement to a device of the second user for presentation.

8. The method of claim 6, further comprising:
receiving a third drag and drop event message from the first user device indicating that the first user has dragged second content;
determining the first user identifier in response to receiving the third drag and drop event message;
retrieving the first user profile using the first user identifier;
processing the first user profile to identify a social connection between the first user and the second user;
obtaining the second user identifier from the first user profile;
obtaining a second user profile for the second user using the second user identifier, wherein the second user profile identifies a user category of the second user;
selecting a second advertisement based on the user category of the second user; and
communicating the second advertisement to a device of the second user for presentation.

9. A non-transitory computer readable medium storing instructions that, when executed, cause an apparatus at least to perform:
receiving a drag and drop event message indicating that a first user has dragged content from a source window to a destination window on a split screen display of a first user device;
determining an identifier of the first user in response to receiving the drag and drop event message;
retrieving a first user profile of the first user using the first user identifier, wherein the first user profile identifies a user category of the first user;
selecting an advertisement based on the user category; and
communicating the advertisement to the first user device for presentation.

10. The non-transitory computer readable medium of claim 9, wherein the destination window is associated with a software application implementing a communication session between the first user device and a user device of a second user, and wherein the instructions, when executed, further cause the apparatus to perform communicating the advertisement to the second user device for presentation.

11. The non-transitory computer readable medium of claim 10, wherein the instructions, when executed, further cause the apparatus to perform selecting the second user based on the first user profile indicating a social connection between the first user and the second user.

12. The non-transitory computer readable medium of claim 9, wherein the event message comprises a unique code that is a function of a time that a drag and drop event occurred on the first user device and an identifier of the content, and wherein the instructions, when executed, further cause the apparatus to perform:
identifying a second drag and drop event message comprising the unique code;
determining a second user identifier in response to receiving the second drag and drop event message, wherein the second user identifier is associated with a second user; and
updating the first user profile to indicate a social connection between the first user and the second user.

13. The non-transitory computer readable medium of claim 12, wherein the instructions, when executed, further cause the apparatus to perform:
retrieving a second user profile of the second user using the second user identifier, wherein the second user profile identifies a second user category of the second user;
selecting a second advertisement based on the second user category; and
communicating the second advertisement to a device of the second user for presentation.

14. The non-transitory computer readable medium of claim 12, wherein the instructions, when executed, further cause the apparatus to perform:
receiving a third drag and drop event message from the first user device indicating that the first user has dragged second content;
determining the first user identifier in response to receiving the third drag and drop event message;
retrieving the first user profile using the first user identifier;
processing the first user profile to identify a social connection between the first user and the second user;
obtaining the second user identifier from the first user profile;
obtaining a second user profile for the second user using the second user identifier, wherein the second user profile identifies a user category of the second user;
selecting a second advertisement based on the user category of the second user; and
communicating the second advertisement to a device of the second user for presentation.

15. An apparatus comprising:
means for receiving a drag and drop event message indicating that a first user has dragged content from a source window to a destination window on a split screen display of a first user device;
means for determining an identifier of the first user in response to receiving the drag and drop event message;
means for retrieving a first user profile of the first user using the first user identifier, wherein the first user profile identifies a user category of the first user;
means for selecting an advertisement based on the user category; and
means for communicating the advertisement to the first user device for presentation.

16. The apparatus of claim 15, wherein the destination window is associated with a software application implementing a communication session between the first user device and a user device of a second user, and wherein the apparatus further comprises means for communicating the advertisement to the second user device for presentation.

17. The apparatus of claim 16, further comprising means for selecting the second user based on the first user profile indicating a social connection between the first user and the second user.

18. The apparatus of claim 15, wherein the event message comprises a unique code that is a function of a time that a drag and drop event occurred on the first user device and an identifier of the content, wherein the apparatus further comprises:
means for identifying a second drag and drop event message comprising the unique code;
means for determining a second user identifier in response to receiving the second drag and drop event message, wherein the second user identifier is associated with a second user; and
means for updating the first user profile to indicate a social connection between the first user and the second user.

19. The apparatus of claim 18, further comprising:
means for retrieving a second user profile of the second user using the second user identifier, wherein the second user profile identifies a second user category of the second user;
means for selecting a second advertisement based on the second user category; and
means for communicating the second advertisement to a device of the second user for presentation.

20. The apparatus of claim 18, further comprising:
means for receiving a third drag and drop event message from the first user device indicating that the first user has dragged second content;
means for determining the first user identifier in response to receiving the third drag and drop event message;
means for retrieving the first user profile using the first user identifier;
means for processing the first user profile to identify a social connection between the first user and the second user;
means for obtaining the second user identifier from the first user profile;
means for obtaining a second user profile for the second user using the second user identifier, wherein the second user profile identifies a user category of the second user;
means for selecting a second advertisement based on the user category of the second user; and
means for communicating the second advertisement to a device of the second user for presentation.
